(19) United States
(12) Patent Application Publication
(10) Pub. No.: US 2012/0131069 A1
(43) Pub. Date: May 24, 2012

(54) OBJECT CONSOLIDATION TO A GRID OF A VIRTUAL MACHINE

(75) Inventors: Snehal S. Antani, Hyde Park, NY (US); Kulvir S. Bhogal, Austin, TX (US); Nitin Gaur, Austin, TX (US)

(73) Assignee: INTERNATIONAL BUSINESS MACHINES CORPORATION, ARMONK, NY (US)

(21) Appl. No.: 12/949,373

(22) Filed: Nov. 18, 2010

(51) Int. Cl. G06F 17/30; G06F 9/455

(52) U.S. Cl. 707/813; 707/E17.007

(57) ABSTRACT

A method for consolidating objects to a grid of a virtual machine may include allocating, by a virtual machine operating on a processing device, each new object into an allocate space of a new memory area for newly created objects in a virtual machine memory of the virtual machine. The new memory area may include the allocate space and a survivor space. The method may also include performing a garbage collection process in response to the allocate space becoming substantially full of objects and copying at least some objects in the allocate space into either the survivor space or a tenured space in the virtual machine memory in response to the garbage collection process. The method may also include transferring a selected object from the tenured space to the grid of the virtual machine in response to a predetermined criterion.

### BACKGROUND

Aspects of the present invention relate to virtual machines and consolidation of objects associated with such machines, and more particularly to a method, system and computer program product for consolidating or saving objects to a grid of a virtual machine.

In virtual machines, such as a Java Virtual Machine (JVM) or other virtual machines, objects or data objects may be created for use by the virtual machine. Java is a trademark of Sun Microsystems, Inc. in the United States, other countries or both. The objects are typically stored in a memory area associated with the virtual machine. The memory area used by a JVM may be referred to as a JVM heap. The memory area associated with a virtual machine or JVM heap may not be adequate at times because of the significant size of some objects, exponential growth in the number of objects or other reasons that the memory area or JVM heap does not have enough capacity. However, there may still be a need to store many of the objects created so that they can be reused. This can present a challenge if decisions need to be made as to which objects need to be stored for reuse.

### BRIEF SUMMARY

According to another aspect of the present invention, a method for consolidating objects to a grid of a virtual machine may include allocating, by a virtual machine operating on a processing device, each new object into an allocate space of a new memory area for newly created objects in a virtual machine memory of the virtual machine. The new memory area may include the allocate space and a survivor space. The method may also include performing a garbage collection process in response to the allocate space becoming substantially full of objects or filed and copying at least some objects in the allocate space into either the survivor space or a tenured space in the virtual machine memory in response to the garbage collection process. The method may also include transferring a selected object from the tenured space to a grid of the virtual machine in response to a predetermined criterion.

According to another aspect of the present invention, a system for consolidating objects to a grid of a virtual machine may include a processing device and a virtual machine operating on the processing device. A virtual machine memory is associated with the virtual machine for storing objects. The virtual machine memory may include a new memory area and a tenured space. The system may also include a grid of the virtual machine. An object consolidation grid agent may be provided for transferring a selected object from the tenured memory area to the grid of the virtual machine in response to a predetermined criterion.

According to a further aspect of the present invention, a computer program product for consolidating objects to a grid of a virtual machine may include a computer readable storage medium having computer readable program code embodied therewith. The computer readable program code may include computer readable program code configured to allocate each new object into an allocate space of a new memory area for newly created objects in a virtual machine memory of the virtual machine. The new memory area may include the allocate space and a survivor space. The computer readable program code may also include computer readable program code configured to perform a garbage collection process in response to the allocate space becoming substantially full of objects or filed. The computer readable program code may also include computer readable program code configured to copy at least some objects in the allocate space into either the survivor space or a tenured space in the virtual machine memory in response to the garbage collection process. The computer readable program code may further include computer readable program code configured to transfer a selected object from the tenured space to a grid of the virtual machine in response to at least one of the tenured space being substantially full, the selected object exceeding a chosen size and the selected object being reusable or being flagged for reuse.

### BRIEF DESCRIPTION OF THE SEVERAL VIEWS OF THE DRAWINGS

The present invention is further described in the detailed description which follows in reference to the noted plurality of drawings by way of non-limiting examples of embodiments of the present invention in which like reference numerals represent similar parts throughout the several views of the drawings and wherein:

FIG. 1 is a block schematic diagram of an example of a system for consolidating objects to a grid of a virtual machine in accordance with an embodiment of the present invention.

FIG. 2 is a flowchart of an example of a method for consolidating objects to a grid of a virtual machine in accordance with an embodiment of the present invention.

FIGS. 3A and 3B are an illustration of a garbage collection process or scavenge of a virtual machine memory area or Java heap in accordance with an embodiment of the present invention.

FIG. 3C is an illustration of switching roles or functions and designations between an allocate space and a survivor space in a new memory area of a virtual machine memory in accordance with an embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

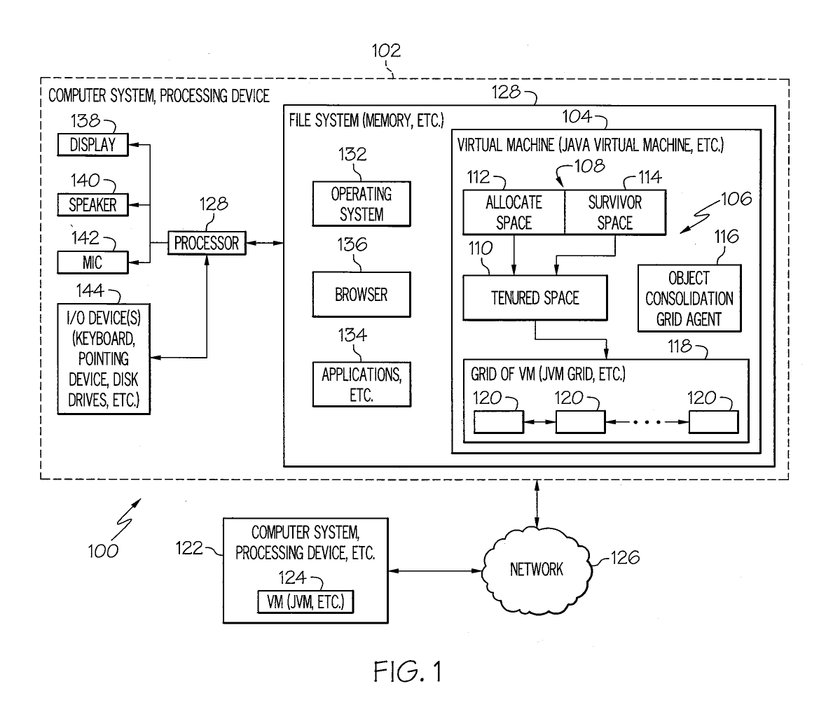

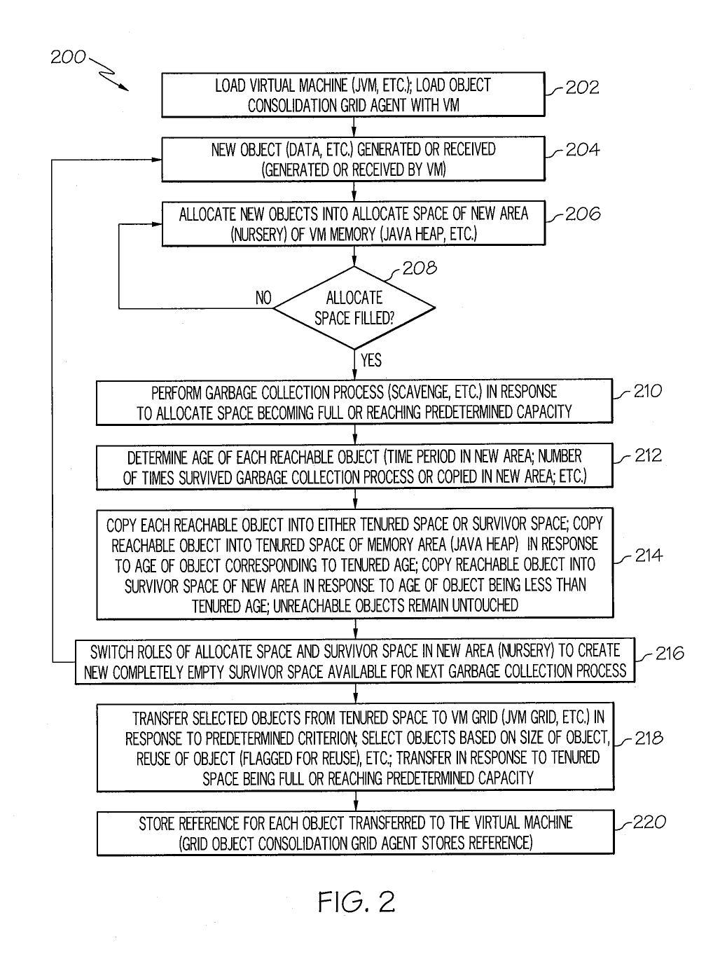

FIG. 1 is a block schematic diagram of an example of a system 100 for consolidating objects to a grid of a virtual machine in accordance with an embodiment of the present invention. The method 200 described with reference to FIG. 2 may be embodied in or performed by the system 100. The system 100 may include a processing device 102 or other device. The system 100 may include a virtual machine 104 operating on the processing device 102. The virtual machine 104 may be a Java Virtual Machine (JVM) or other virtual machine. The virtual machine 104 may include or may be associated with virtual machine memory 106. In a JVM, the virtual machine memory 106 is referred to as a JVM heap. The virtual machine memory 106 or JVM heap may be divided into two memory areas. One memory area is a new memory area 108 or nursery. Newly created objects are stored in the new memory area 108. The other memory area of the VM memory 106 is an old memory area or tenured memory area or tenured space 110. Older, tenured objects which have been retained for reuse may be stored in the tenured space 110. The objects may be data objects or any other objects useable by the virtual machine or another application or program. An object may be created in the new area 108 or created by the virtual machine 104 and allocated to the new area 108. If an object continues to be reachable long enough or for a preset time period, the object may be considered to have reached a tenured age and may be moved or copied into the old memory area or tenured space 110. In another aspect of the invention, an object may have reached a tenured age and may be moved or transferred to the tenured space 110 when the object has been reachable for a predetermined number of garbage collection processes or scavenges to remove objects that are unreachable or have not been reused or are expected to be reused. As described in more detail herein, a garbage collection process or scavenge may be performed in response to the new memory area 108 or a portion of the new memory area 108 becoming substantially full or filed. Reachable objects may be written or copied to the tenured space 114 to provide capacity for additional new objects.

A reachable object may be defined as an object for which there exists some variable in a program environment that leads to object. For example, a reachable object may be accessed or used and reused by the virtual machine or other application or program.

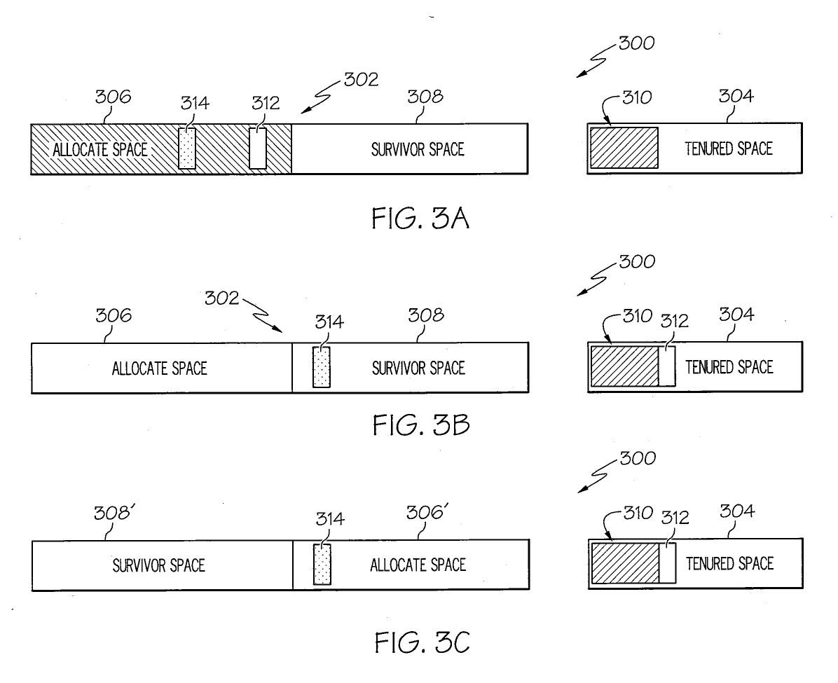

The new memory area 108 may be split or divided into two logic spaces, an allocate space 112 and a survivor space 114. As described in more detail herein, when the allocate space 112 is substantially filled or reaches a predetermined level of capacity, the garbage collection process or scavenge may be triggered or performed. During a scavenge, reachable objects are copied either into the survivor space 114 or into the tenured space 110. A respective reachable object may be copied into the tenured space 110 if the respective reachable object has reached the predetermined tenured age otherwise the reachable object may be copied into the survivor space 114. Objects in the new memory area 108 that are not reachable may remain untouched or may be removed. As described in more detail with reference to FIGS. 3A and 3B, when all reachable objects have been copied from the allocate space 112 to either the tenured space 110 or the survivor space 114 and non-reachable objects removed, the allocate space 112 and the survivor space 114 memory areas may switch roles and designations. The previous allocate space 112 becomes the new survivor space 114 and the previous survivor space becomes the new allocate space 112. The new survivor space 114 is now entirely empty of reachable objects and is available for the next scavenge or garbage collection process. The new allocate space 112 will include any reachable objects that have not attained the tenured age and which were copied to the survivor space 114 during the last scavenge or any earlier scavenges.

The virtual machine 104 may also include an object consolidation grid agent 116. The object consolidation grid agent 116 may also be referred to as an object overflow grid agent. The object consolidation grid agent 116 may be loaded with the virtual machine and enables overflow of the tenured space 110 into a grid of the virtual machine 118, virtual machine (VM) grid or JVM grid. A selected object may be transferred from the tenured space 110 to the grid of the virtual machine 118 in response to a predetermined criterion. Examples of the predetermined criterion may include at least one of the tenured space being full, substantially filed but not completely filled, the tenured space being filled to a predetermined level of capacity, the selected object being a chosen size or exceeding a chosen size, the selected object being reusable by other applications or programs, the object being flagged for reuse, or some other criterion.

The grid of the virtual machine 118 is a storage arrangement for reusable objects 120 or objects that may be used and reused by the virtual machine 104 and by other entities 122, such as other computer systems, virtual machines 124, applications, programs or the like. The objects 120 may be shared via a network 126. The grid of the virtual machine 118 shares resources that include data for use by other entities 122 or nodes on the network 126 for example in a grid computing environment. The network 126 may be the Internet, an intranet, or some other private or proprietary network.

The grid of the virtual machine 118 may provide a set of interconnected java processes that hold data or data objects in memory. The grid 118 thereby may provide a single address space which can be extended by adding additional virtual machines to the existing grid. This enables faster data access as the data or objects are accessed from memory.

As illustrated in FIG. 1, the grid of the virtual machine 118 may be part of the virtual machine memory 106. In another embodiment, the grid of the virtual machine 118 may be a separate memory or data storage device that may be associated with the virtual machine 104. The grid of the virtual machine 118 may also be located at a different location on the network 126.

The computer system 100 may include any sort of computing device or processing device 102 and may include a communications device such as a mobile or handheld computer or communications device. The processing device 102 may include a processor 128 to control operation of the computer system 100 or processing device 102. The computer system 100 may also include a file system 130, memory or similar data storage device. The virtual machine 104 may be stored on the file system 130 and run on the processor 128. An operating system 132, applications 134 and other programs may also be stored on the file system 130 for running or operating on the processor 128. A web or Internet browser 136 may also be stored on the file system 130 for accessing other entities, such as system 122 via the network 126.

The computer system 100 or processing device 102 may also include a display 138, a speaker system 140, and a microphone 142 for voice communications. The computer system 100 may also include one or more input devices, output devices or combination input/output devices, collectively I/O devices 144. The I/O devices 144 may include a keyboard or keypad, pointing device, such as a mouse, disk drives and any other devices to permit a user to interface with and control operation of the computer system 100.

FIG. 2 is a flowchart of an example of a method 200 for consolidating objects to a grid of a virtual machine in accordance with an embodiment of the present invention. The method 200 may be embodied in or performed by the system 100 in FIG. 1. In block 202, a virtual machine, such as a Java virtual machine or similar virtual machine may be loaded. An object consolidation grid agent or object overflow grid agent may be loaded with the virtual machine.

In block 204, a new object may be generated by the virtual machine or maybe received by the virtual machine. The object may be a data object or other type object usable by the virtual machine or other applications or programs.

In block 206, the new object may be stored or allocated into an allocate space of a new memory area or nursery of the virtual machine memory or Java heap if the virtual machine is a JVM.

In block 208, a determination may be made if the allocate space is filled, or substantially filled or has reached or exceeded a predetermined level of capacity. If the allocate space is not filled or exceeded the predetermined level of capacity, the method 200 may return to block 206 and additional new objects may be allocated or stored in the allocate space. If the allocate space of the new memory area is full or substantially filled or has exceeded the predetermined level of capacity in block 208, the method 200 may advance to block 210. In block 210, a garbage collection process or scavenge may be performed in response to the allocate space becoming full or substantially filled or reaching or exceeding the predetermined level of capacity.

In block 212, an age of each reachable object in the allocate space of the new memory area may be determined to determine which reachable objects have reached the predetermined tenured age. Examples of determining the age of an object in the allocate space may include but is not necessarily limited to determining a time period or time duration that the object has been reachable in the allocate space; determining the number of garbage collection processes or scavenges the object has survived and been reachable in the allocate space; or determining the number of times the object has been copied to the survivor space.

In block 214, at least some objects or each reachable object may be copied into either the tenured space or the survivor space. The reachable object may be copied into the tenured space of the virtual machine memory in response to an age of the reachable object corresponding to the tenured age. The reachable object may be copied into the survivor space of the new memory area in response to the age of the object being less than the tenured age. The tenured age may correspond to the object being reachable in the allocate space of the new memory area for at least a preset time. Or the tenured age may correspond to the object being reachable for a predetermined number of garbage collection processes or scavenges. Non-reachable objects may remain untouched in the new memory area.

In block 216, the roles of the allocate space and the survivor space may be switched in the new memory area or nursery to create an empty survivor space available for the next garbage collection process, similar to that previously described.

In block 218, selected objects may be transferred from the tenured space to a grid of the virtual machine or JVM grid (if the virtual machine is a Java virtual machine) in response to a predetermined criterion. Examples of the selected criterion may include but is not necessarily limited to the tenured space being substantially full, the selected object exceeding a chosen size, the selected object in being reusable, or the selected object being flagged or designated for reuse by other virtual machines, applications, programs or the like. As previously discussed, the selected objects may be transferred from the tenured space to the grid of the virtual machine by an object consolidation grid agent or object overflow grid agent.

In block 220, a reference for each object transferred to the grid of the virtual machine may be stored. The reference may be stored by the object consolidation grid agent. The reference may provide an identification of the object, a brief description of the object or other data that may be useful for determining or permitting access to the objects stored on the grid of the virtual machine.

FIGS. 3A and 3B are an illustration of a garbage collection process or scavenge of a virtual machine memory area or Java heap in accordance with an embodiment of the present invention. As previously discussed, a virtual machine memory may include a new memory area 302 and an old area 304. The new memory area 302 may include an allocate space 306 and a survivor space 308. The old area 304 may also be referred to as a tenured space. FIG. 3A illustrates the new memory area 302 and the tenured space 304 before the garbage collection process. FIG. 3B illustrates the new memory area 302 and the tenured space 304 after the garbage collection process.

As previously discussed reachable objects which have reached the tenured age may be copied into the tenured space 304 during a garbage collection process or scavenge. The crossed hatched area 310 in the tenured space 304 in FIG. 3A represents tenured objects which have been copied into the tenured space 304 during previous garbage collection processes.

As new objects are created, the objects are allocated or stored in the allocate space 306 as illustrated by new objects 312 and 314 in FIG. 3A. A garbage collection process or scavenge is triggered in response to the allocate space 306 becoming full or substantially filled as illustrated by the cross-hatching in the allocate space 306 in FIG. 3A or the allocate space 306 reaching a predetermined level of capacity. During the garbage collection process, any reachable objects, such as reachable object 312 in FIG. 3A, are copied to the tenured space 304 if the age of the reachable object corresponds to or equals the predetermined tenured age. Any reachable objects, such as reachable object 314 in FIG. 3A, are copied to the survivor space 308 in response to the age of the reachable object 314 being less than the predetermined tenured age. Any unreachable objects or objects which have not been used or reused are untouched and may be emptied from the allocate space 306 during the garbage collection process.

FIG. 3C is an illustration of switching roles or functions and designations between the allocate space 306 and the survivor space 308 in the new memory area 302 or nursery in accordance with an embodiment of the present invention. In FIG. 3C, the roles or functions of the allocate space 306 and the survivor space 308 may be switched. In other words, the survivor space 308 may become the new allocate space 306′ and the allocate space 306 may become the new survivor space 308′ to provide a new completely empty survivor space 308′ for the next garbage collection process.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to embodiments of the invention in the form disclosed. Many modifications and variations will be apparent to those of ordinary skill in the art without departing from the scope and spirit of embodiments of the invention. The embodiment was chosen and described in order to best explain the principles of embodiments of the invention and the practical application, and to enable others of ordinary skill in the art to understand embodiments of the invention for various embodiments with various modifications as are suited to the particular use contemplated.

Although specific embodiments have been illustrated and described herein, those of ordinary skill in the art appreciate that any arrangement which is calculated to achieve the same purpose may be substituted for the specific embodiments shown and that embodiments of the invention have other applications in other environments. This application is intended to cover any adaptations or variations of the present invention. The following claims are in no way intended to limit the scope of embodiments of the invention to the specific embodiments described herein.

What is claimed is:

1. A method for consolidating objects to a grid of a virtual machine, comprising:
allocating, by a virtual machine operating on a processing device, each new object into an allocate space of a new memory area for newly created objects in a virtual machine memory of the virtual machine, wherein the new memory area comprises the allocate space and a survivor space;
performing a garbage collection process in response to the allocate space becoming substantially full of objects;
copying at least some objects in the allocate space into either the survivor space or a tenured space in the virtual machine memory in response to the garbage collection process; and
transferring a selected object from the tenured space to the grid of the virtual machine in response to a predetermined criterion.

2. The method of claim 1, wherein copying at least some objects in the allocate space comprises:
copying a respective reachable object to the tenured space in response to an age of the respective reachable object corresponding to a tenured age; and
copying the respective reachable object to the survivor space in response to the age of the respective reachable object being less than the tenured age.

3. The method of claim 2, wherein the tenured age corresponds to the respective object being reachable in the new memory area for at least a preset time period.

4. The method of claim 2, wherein the tenured age corresponds to the respective object having been reachable for a predetermined number of garbage collection processes.

5. The method of 1, further comprising loading an object consolidation grid agent with the virtual machine, wherein transferring the selected object from the tenured space to the grid of the virtual machine comprises transferring the selected object by the object consolidation grid agent.

6. The method of claim 5, wherein the object consolidation grid agent resides on the virtual machine.

7. The method of 5, further comprising storing a reference for each object transferred to the grid of the virtual machine by the object consolidation grid agent.

8. The method of claim 1, wherein the predetermined criteria comprises at least one of the tenured space being substantially full, the selected object exceeding a chosen size and the selected object being reusable.

9. The method of claim 1, wherein transferring the selected object from the tenured space to the grid of the virtual machine comprises transferring the selected object to the grid of the virtual machine in response to the selected object exceeding a chosen size.

10. The method of claim 1, wherein transferring the selected object from the tenured space to the grid of the virtual machine comprises transferring the selected object to the grid of the virtual machine in response to the selected object being flagged for reuse by other applications or virtual machines.

11. The method of claim 1, wherein any objects that are not reachable in the new memory area remain untouched.

12. The method of claim 1, further comprising switching roles of the allocate space and the survivor space in the new memory area to provide an empty survivor space available for a next garbage collection process.

13. A system for consolidating objects to a grid of a virtual machine, comprising:
a processing device;
a virtual machine operating on the processing device;
a virtual machine memory associated with the virtual machine for storing objects, wherein the virtual machine memory comprises a new memory area and a tenured space;
a grid of the virtual machine; and
an object consolidation grid agent for transferring a selected object from the tenured memory area to the grid of the virtual machine in response to a predetermined criterion.

14. The system of claim 13, wherein the predetermined criteria comprises at least one of the tenured space being substantially full, the selected object exceeding a chosen size and the selected object being reusable.

15. The system of claim 13, wherein the new memory area comprises an allocate space and a survivor space, each new object being allocated into the allocate space and a garbage collection process being performed in response to the allocate space becoming substantially full, wherein a respective reachable object in the allocate space is copied into the tenured space during the garbage collection process in response to an age of the respective reachable object corresponding to a tenured age, and the respective reachable object is copied into the survivor space during the garbage collection process in response to the age of the respective reachable object being less than the tenured age.

16. The system of claim 15, wherein the tenured age corresponds to one of the respective object being reachable in the new memory area for at least a preset time period and the respective object having been reachable for a predetermined number of garbage collection processes.

17. A computer program product for consolidating objects to a grid of a virtual machine, the computer program product comprising:
a computer readable storage medium having computer readable program code embodied therewith, the computer readable program code comprising:
computer readable program code configured to allocate each new object into an allocate space of a new memory area for newly created objects in a virtual machine memory of the virtual machine, wherein the new memory area comprises the allocate space and a survivor space;
computer readable program code configured to perform a garbage collection process in response to the allocate space becoming substantially full of objects;
computer readable program code configured to copy at least some objects in the allocate space into either the survivor space or a tenured space in the virtual machine memory in response to the garbage collection process; and
computer readable program code configured to transfer a selected object from the tenured space to the grid of the virtual machine in response to at least one of the tenured space being substantially full, the selected object exceeding a chosen size and the selected object being reusable.

18. The computer program product of claim 17, wherein the computer readable program code configured to copy at least some objects in the allocate space comprises:
computer readable program code configured to copy a respective reachable object to the tenured space in response to an age of the respective reachable object corresponding to a tenured age; and
computer readable program code configured to copy the respective reachable object to the survivor space in response to the age of the respective reachable object being less than the tenured age, wherein the tenured age corresponds to one of the respective object being reachable in the new memory area for at least a preset time period and the respective object having been reachable for a predetermined number of garbage collection processes.

19. The computer program product of claim 17, further comprising:
computer readable program code configured to load an object consolidation grid agent with the virtual machine, wherein transferring the selected object from the tenured space to the grid of the virtual machine comprises transferring the selected object by the object consolidation grid agent; and
computer readable program coded configured to store a reference for each object transferred to the grid of the virtual machine by the object consolidation grid agent.

20. The computer program product of claim 18, further comprising computer program product code configured to switch roles of the allocate space and the survivor space in the new memory area to provide an empty survivor space available for a next garbage collection process.
